(19) United States
(12) Patent Application Publication
(10) Pub. No.: US 2003/0201074 A1
(43) Pub. Date: Oct. 30, 2003

(54) Rigid and sturdy screen door assembly with a positive track and a self leveling hanger gliding adapter

(76) Inventor: Frank J. Schnoor, Corvallis, OR (US)

Correspondence Address: Frank J. Schnoor, 3310 SW Willamette, Corvallis, OR, 97333, US

(21) Appl. No.: 10/136,879

(22) Filed: Apr. 30, 2002

(51) Int. Cl. E06B 3/42

(52) U.S. Cl. 160/90

(57) ABSTRACT

The present invention is a screen frame and screen cloth positioned in a sliding door frame. The invented screen frame is formed by the use of two vertical hat stiles with the intersection of three horizontal hat stiles to form a rectangular frame by riveting four corners of the frame, further riveting the horizontal stile to the vertical to make the frame a two-piece section for insertion of the screen cloth. The screen frame and screen insert provides a long lasting rigid and sturdy unit.

### BACKGROUND

1. Field of Invention

The present invention relates to a sliding door frame screen. More particularly the invention relates to a sturdy, rigid aluminum extrusion of 0.060 thickness. The frame is formed by fitting the aluminum sections into a solid frame that will enable the invention to become a system for mounting a horizontally sliding door into a top hung assembly wherein the frame screen has its top horizontal stile mounted in a hanger assembly that fits into a track that allows the unit to glide on top rollers and the screen cloth to be a 2-piece section unit.

The sliding door is opened and closed by a handle and latch in a top hung roller and a bottom gliding unit.

2. Description of Prior Art

Sliding screen doors of the type used with a common sliding patio door have a myriad of problems associated with them due to the typical design whereby the screen door is a large one-piece, flimsy screen section that does not allow for stable operation. These problems include flimsy construction, difficult operation due to dirt and debris clogging the bottom track and the fact that the mechanism is often exposed to the weather due to its position, the tendency to “pop off the bottom track and the inability of the screen to be adjusted to fit an uneven frame. As such, many sliding screen doors are either in disrepair from acts such as pushing too hard on the door in order to move it, or removed due to the problems and not replaced, as the same problems will occur again, and/or are not used.

While there are a number of prior art patents that show hanger assemblies for adjustably supporting doors for sliding movement along a horizontally disposed track, not one shows or suggests an assembly for use with a screen door. The prior art hanger assemblies are shown being used or suggest use only with interior sliding pocket doors, shower doors, closet doors and sound absorption panels. In addition, the prior art does not show a hanger assembly that allows for simple, economical and complete adjustability, i.e. vertical and horizontal adjustability of any type of door in combination with the hanger assembly providing equal hanging support on both sides of a door in order to maintain smooth and continuous sliding movement of the door.

In typical handle latch assembly, all moving parts of the latch are packed into a small area of the screen, which is inadequate.

For example, U.S. Pat. No. 3,057,005 to Dishaw discloses a sliding door hanger that allows for vertical adjustment only via a specially manufactured threaded bolt.

U.S. Pat. No. 3,239,891 to Gardner discloses a panel structure with a hanger that allows for vertical adjustment only via an inclined slot at its upper end.

U.S. Pat. No. 3,311,942 to Edeus discloses a hanger assembly for sliding doors that allows for vertical adjustment only through the use of a circular hand wheel.

U.S. Pat. No. 3,555,612 to Procton discloses a hanger assembly that utilizes parallel angularly displaced slots for permitting horizontal and vertical positioning of a door.

Objects And Advantages

Accordingly, several objects of the present invention are to provide:

a. continuous, smooth and easy operation of a sliding screen door, with built-in rigidity;

b. a design whereby the operating mechanism is protected from flimsiness and weather;

c. a simple way to convert or to replace existing sliding screen doors to top rolling sliding screen doors whereby the bottom existing rollers operate as guides only;

d. for simple installation and conversion or replacement of screen doors due to the ability to adjust the top mounting assembly to fit uneven frames;

e. for a device that adapts to industry standard replacement screens, custom screens, or existing screens; and

f. to provide for a screen that stays in the roller track.

g. An adequate and lengthy screen locking device.

These and further objects will be apparent from the following description and drawings of the preferred embodiments thereof.

### BRIEF SUMMARY OF THE INVENTION

The invention is the use of a top mounting hanger assembly with sliding screen doors that allows for both vertical and horizontal adjustability of the screen door while equally supporting the screen door on both sides of the door. The hanger assembly generally comprises a track horizontally mounted within a door frame and a roller assembly, the roller assembly including a roller for horizontal movement along the track and a holder, said holder including a connector bar attached to the roller at one end and a bracket shaped to fit snugly around a screen door. The bracket also includes a slot for adjustability of the screen door within the bracket. Preferably, the track is an integral molded extrusion that includes a c-shaped area with lips that retain the roller assembly roller within the track, and upwardly extending flanges and a downwardly extending c-shaped area that together interlock and allow two track pieces to fit together thereby reducing bulkiness in shipping. The track preferably also includes a horizontally extending “bug strip” that acts to prevent weathering of the hanger assembly. Preferably, two roller assemblies are utilized per screen door, one attached at each end of the screen door, and include two rollers per roller assembly. The roller assembly holder is also an integrally molded extrusion and the bracket portion is in the shape of a U, the U-shaped portion including the slot, which is preferably either vertically disposed for vertical adjustment of the screen door, or angularly disposed for vertical and horizontal adjustment of the screen door.

And to further make the new screen door a more rigid and sturdy unit by fitting 0.060 extruded aluminum parts that will make a rectangular frame by use of two vertical hat profile screen frame stiles with a flange that will extend from the U-shape of the bracket portion to the bottom bracket track with a refitted roller guide fitted through each of the vertical hat profile stiles to flanges refitted with the three or more hat profile horizontal screen stiles to be riveted as one frame with two panels of the screen cloth. And further, the screen is opened and closed by an adequate handle and latch assembly.

From the foregoing, it is readily apparent that I have invented a long-lasting screen and frame ensemble.

### DESCRIPTION OF THE DRAWING

FIG. 1. A partial perspective top view of the preferred embodiment of the screen door and assembly. Seated in a screen channel of a sliding patio door from head section.

FIG. 2. Shows bottom views of the preferred embodiment of the screen door hanger assembly of FIG. 1 and screen door section on the sill of the sliding patio door frame section.

FIG. 3. Shows two sided views of the preferred embodiment of the screen door hanger assembly of FIGS. 1 and 2 showing the vertical adjustment of the screen door between the head and sill of a patio door.

FIG. 4. A front view of preferred embodiment of FIGS. 1, 2 and 3 of the screen door assembly and the screen door showing a complete unit with all of its various horizontal and vertical parts in proper position.

FIG. 5. Is an interior view cutaway of latch and handle assembly seated in the interior lock hat stile unit which secures the screen door in place.

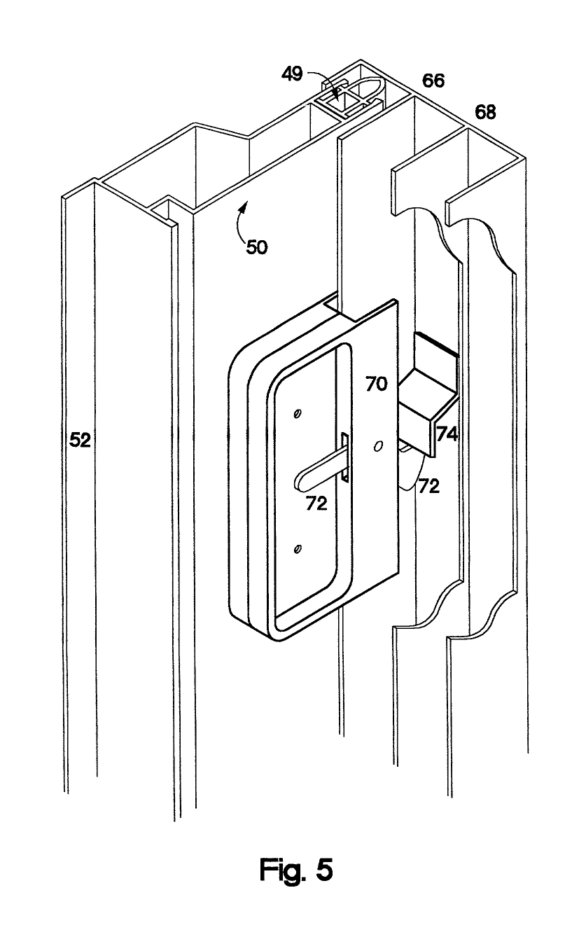

FIG. 6. Shows an economical reuse of a retrofitted screen using my invention.

### DETAILED DESCRIPTION

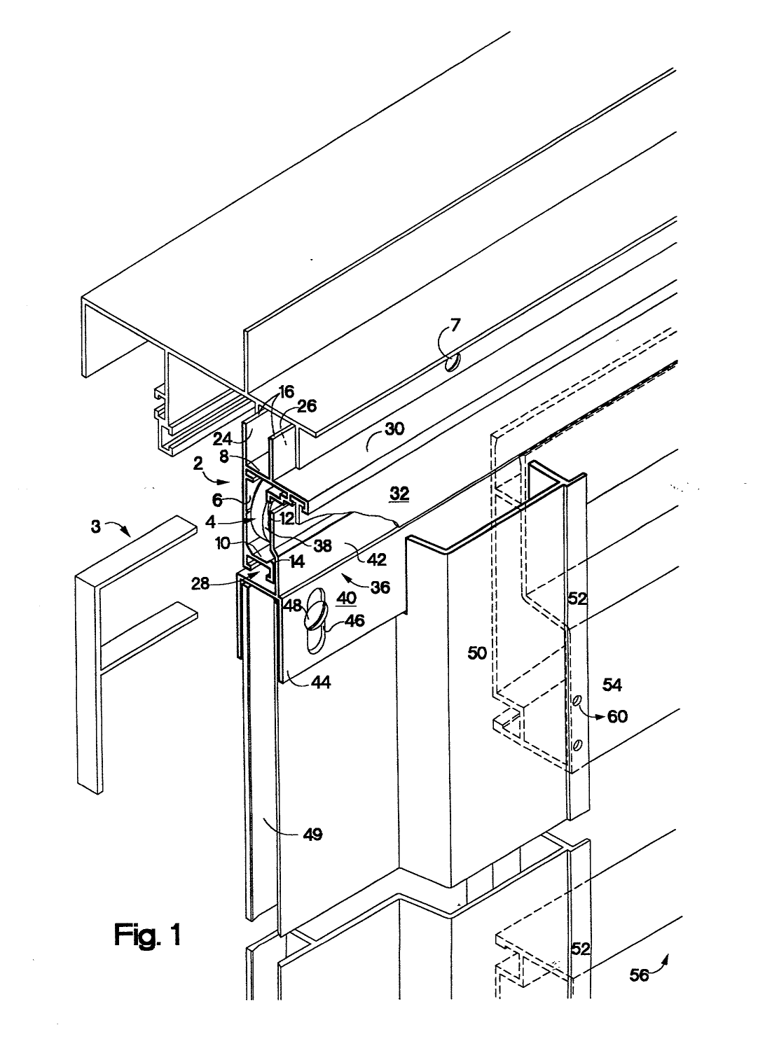

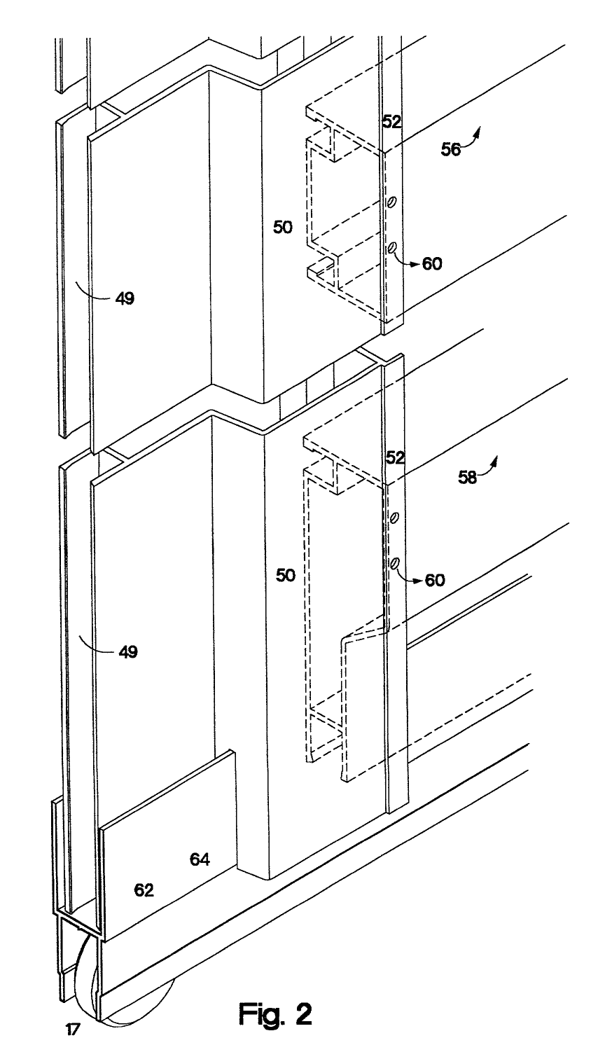

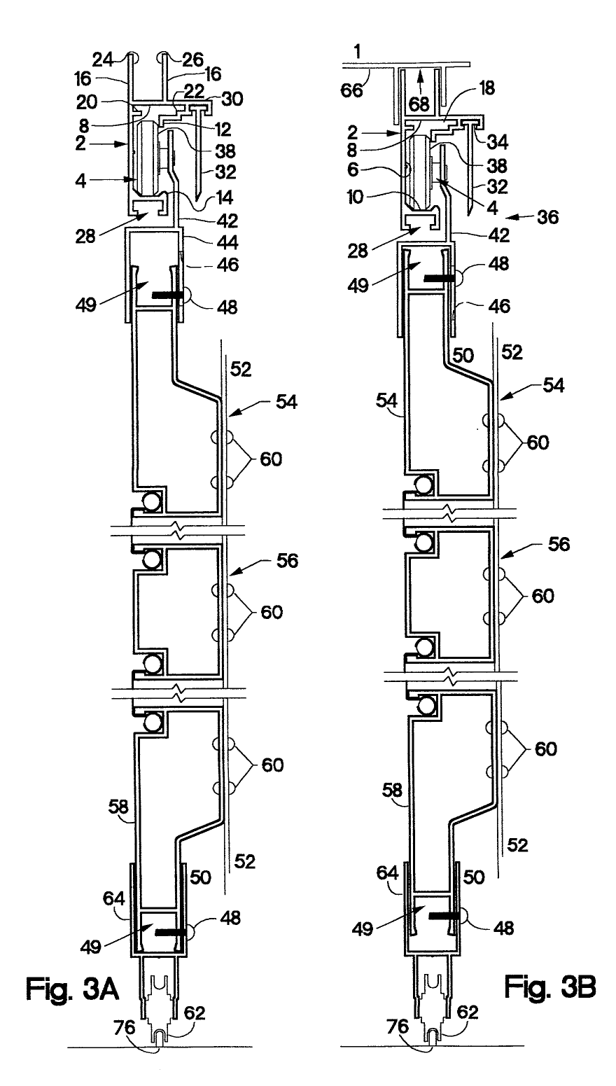

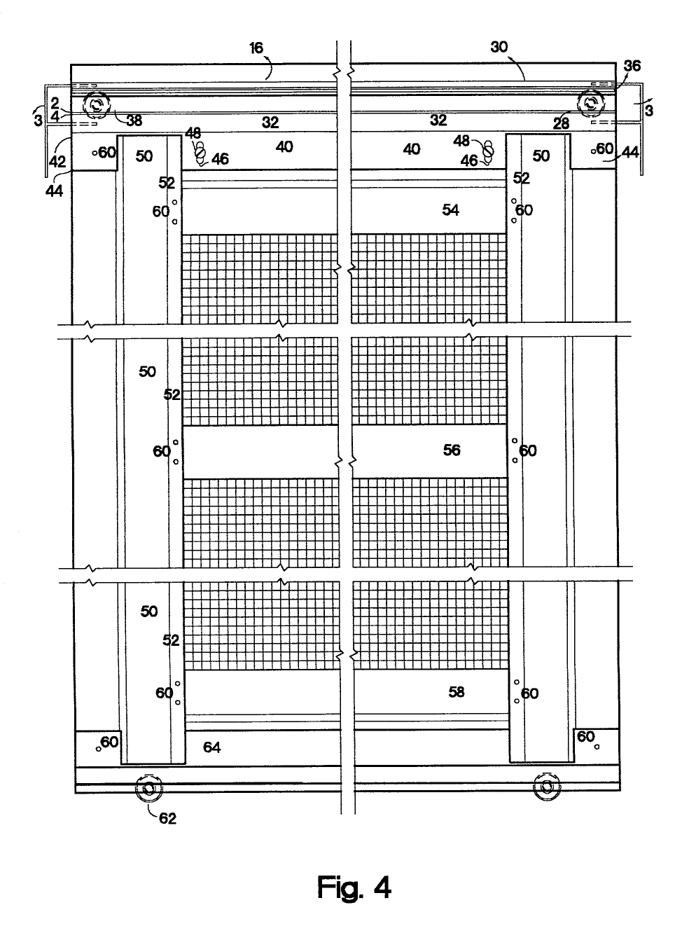

FIGS. 1 through 4 show the preferred embodiment of the hanger and all parts to bottom bracket assembly. The hanger assembly comprises an integrally extruded track (2), which is horizontally mounted and secured to a header of a door preferably with corner adjusters (3). The extended track (2) includes a roller guide area (4) in a C-shape, with square corners including a back (6), a top (8) and bottom (10), the back (6) in a right angle relationship to the top (8) and bottom (10). The top (8) includes a downwardly projecting lip (12) and the bottom (10) includes an upwardly projecting lip (14), each lip (12) and (14) extending along the length of the track (2) opposite the back (6). The track (2) further includes two identical flanges (16) parallel to each other that extend vertically from the outer edges (18) of the top (8) and are in perpendicular relationship to the top (8). The back (6) further includes a rib (20) across from rib (22) coming down from (8) and abutting inward of (30) forming a downward C for the length of the track (2). The bottom (10) includes a downwardly extending C (28), also with square corners in a right angle relationship with the bottom (10). The flanges (16) and the downwardly extending C (28) are shaped in the manner described to allow for the interlocking of two pieces of track (2) for shipping in an economical manner. And for the inclusion of C shape (20) and (22) along with (28) being held up by a corner adjuster (3) at the track (2). The top (8) outer edge further includes an extension (30) extending along the track (2), generally shaped also in a downwardly facing C, for the retention of a bug strip (32) to prevent weathering of the hanger assembly. The bug strip (32) is preferably fashioned of a vinyl material including a thickened top edge (34), the edge shaped and sized to fit snugly in the extension (30).

While this type of track is shown, the track can be of any configuration or material suitable for the movement of rollers along the track for a screen door.

The hanger assembly further comprises a roller assembly (36) for connection of a roller (38) or rollers to a screen door. Preferably the roller assembly (36) includes at least a roller (38) for horizontal movement along the track (2), and an integrally extruded holder (40) for connection of the roller (38) to the screen door. The holder (40) includes a connecting bar portion (42) attached to the roller (38) and an adjustable bracket (44) holding a screen door, the bracket portion (44) shaped generally as a U extending downwardly from the connecting bar portion (42), one side of the U including a slot (46). The slot may be vertically disposed for vertical adjustment or angularly disposed for horizontal and vertical adjustment of the screen door. The screen door fits snugly into the U shape of the bracket portion (44) and can be adjusted up and down by the positioning of a screw (48) or other connecting or attaching means in the slot (44). Preferably, the holder (40) is of the required screened width, with two rollers, one toward each end of the screen door, and preferably there are two rollers (38) per roller assembly (36).

To make the screen a more rigid and sturdy unit. The following aluminum parts should be placed on a flat table for assembling, two vertical hat stiles (50) with flanges (52) will be laid out in a parallel position; then a top horizontal hat stile (54) and bottom horizontal stile (58) will be fitted between the two and spot riveted (60) at the four corners, two at the top (52, 54, 60) and two at the bottom (52, 58, 60). Then a muntin horizontal hat stile (56) will be set in the middle and riveted on (52, 56, 60). This makes a rigid and sturdy rectangular two panel screen frame, ready to spline the screen cloth in place.

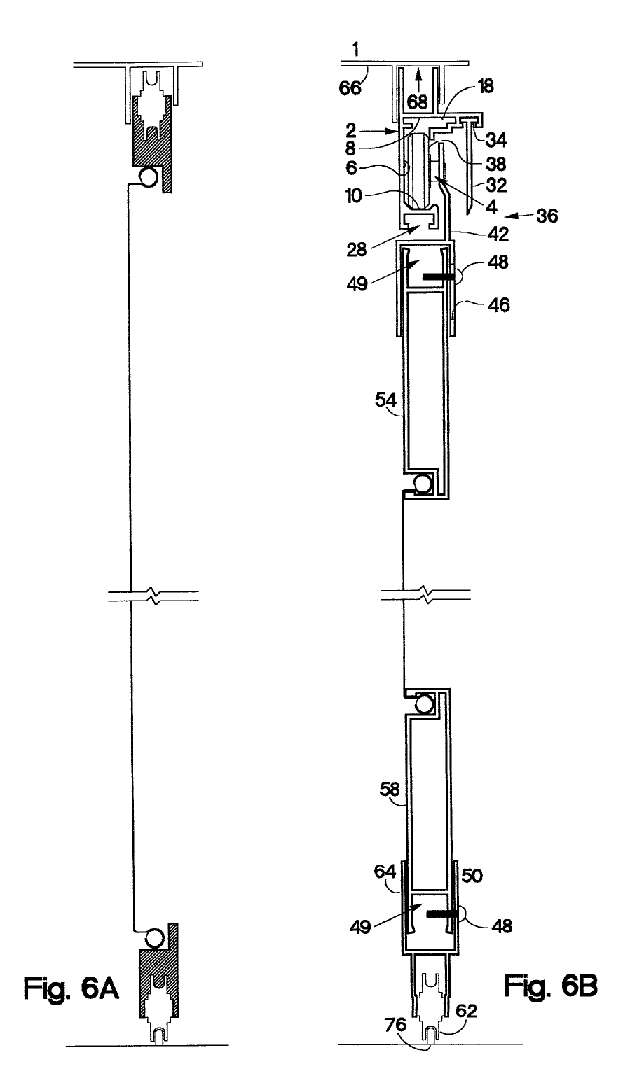

Upon completion the hanger assembly bracket portion (44) of the holder (40) with two ball bearing rollers (38) at each end, will be fitted by the U shape section (49) of the screen top (54) and held in place by two screws (48) at elongated slot (46) and the bottom bracket (64), with a roller guide (62) held in place by a press fit or the stile at the two junctions of (58/49) and (64). The full unit will be lifted in place by the hanger assembly (46) with rollers (38) fitted on the track (2) at the roller guide (4) in a C shape, held in place by use of two screen corner adjusters (3) secured at jamb and screen channel of the patio door frame by screws through the jamb section and if necessary by screws through the patio head section (66) to the flange (26) of the track (2) and then fitted over the door sill (76) with roller guide (62). Any further vertical adjustment will be done at top and bottom U section (49) at screw (48). The installation of the screen listed hereto will also work with a retrofitted screen as shown in FIG. 6. The sliding screen is opened and closed by a handle and latch. The handle (70) is attached to the interior face of the vertical hat stile (50). The latch (72) slides up and down to engage with the received (74) inside the fixed glass channel (68) of the sliding door frame. The installation of the screen assembly latch here to will also work as shown in FIG. 6 with a retrofitted screen (see Description of Prior Art, page 1, line 22 to line 7, page 2). This may be remedied by removing screen from opening, installing the track assembly in the screen channel. Remove the top roller from the screen. Repair the screen but first cut of approximately two inches from the vertical side, by removing horizontal spline about 3 inches or so vertical, to loosen screen cloth and remove both corner bracket and cut two inches from the vertical stile by a miter or a 90° cut. Replace bottom with corner bracket and then spline screen cloth. Then replace hanger assembly on top of screen and fit in C shape (4) of track (2).

What is claimed is a hanger assembly for a sliding screen door comprising:
1. A horizontal track for securing to a header of a door frame by means of two corner screen adjusters fitting in the slots on the top and bottom of the C shape section of the track; a roller assembly, said roller assembly including two rollers positioned in said track for horizontal movement along the track; and a screen hanger assembly including a connector bar portion attached to said roller and a bracket portion, said bracket portion connected to said screen door, and including a slot for adjustment of the screen door (by others) through positioning of connecting means through the slot.

2. What is claimed:
A frame section will be made from two vertical hat section stiles with a ¼″ flange, distributed in parallel to each other by the normal screen with such as 30, 36, 48 inches. Added to this are the two horizontal hat screen, stile top, and bottom. Between the vertical stile at the appropriate position and then pop riveted at four corners. Then a muntin stile will be placed and riveted across the center to form a two panel frame. The screen cloth will then be splined in to make a rigid and sturdy screen. When finished, the U channel of top hat stile will be fitted into the hanger holder and secured and the bottom bracket will also be secured over the U channel of bottom hat stile. The guide roller will be fitted over the sill section.

3. What is claimed:
In all other hanger and latch screen units, those with units are fit to go into the interior section of screen with all locking parts fitting into a one half inch space U channel which is not adequate. This claim is that a full locking unit is attached to interior portion of the screen and the latch and keeper piece is fitted into the fixed glass channel. The lock will work on any new screen or on a retrofitted unit.

4. What is claimed:
The retrofit aspects of the existing screen door when the screen is relieved of the top roller, the vertical stiles are made free to loosen or remove screen cloth, also shorten by two inches and then repaired. The screen will then use patentable parts.
